(19) United States
(12) Patent Application Publication
(10) Pub. No.: US 2013/0250225 A1
(43) Pub. Date: Sep. 26, 2013

(54) DISPLAY DEVICE

(71) Applicants: Kazuhiro Maeda, Osaka (JP); Yousuke Nakagawa, Osaka (JP)

(72) Inventors: Kazuhiro Maeda, Osaka (JP); Yousuke Nakagawa, Osaka (JP)

(73) Assignee: SHARP KABUSHIKI KAISHA, Osaka (JP)

(21) Appl. No.: 13/990,341

(22) PCT Filed: Nov. 24, 2011
(86) PCT No.: PCT/JP2011/077098

§ 371 Date: May 29, 2013

(30) Foreign Application Priority Data
Nov. 30, 2010 (JP) 2010-267517

(51) Int. Cl. G02F 1/1343

(52) U.S. Cl. CPC G02F 1/134336
USPC 349/143

(57) ABSTRACT

The purpose of the present invention is to ensure uniformity among pixels when an electrode for a touch sensor also acts as an electrode for image display at the same time. This display device includes: a circuit substrate; a plurality of pixel electrodes (12) that are arranged in a matrix on a plane that is parallel to the circuit substrate; a liquid crystal layer that can exhibit an image display function on the basis of an image signal supplied to the plurality of pixel electrodes (12), a plurality of driver electrodes (14) arranged in the same layer with gaps therebetween, which can generate an electric field with the pixel electrodes (12) to alter the state of the liquid crystal layer; and a plurality of detection electrodes in the same layer that can be capacitively coupled to the plurality of driver electrodes, respectively, in which at least one of the plurality of driver electrodes (14) is provided with slits (20).

### TECHNICAL FIELD

The present invention relates to a display device having a capacitive-type touch sensor function.

### BACKGROUND ART

A conventional touch panel that detects a position where a finger or a stylus of a user comes into contact with or approaches the touch panel is known. Also, display devices with such a touch panel that can detect a position where a finger or a stylus of a user comes into contact with or approaches a display surface of the touch panel are used in many devices.

If a touch panel is provided in a display device such as a liquid crystal panel, the display module such as a liquid crystal module as a whole becomes thick.

As a countermeasure, a technique has been developed in which the same electrode is used for the touch panel and for image display in the display device (Patent Documents 1 to 6). For example, in Patent Document 1, driver electrodes of a plurality of touch sensors are used for scanning driving for the touch sensor, and for the so-called VCOM driving for an image display device at the same time, thus mitigating an increase in thickness of the liquid crystal module.

In Patent Document 2, a common electrode in a display region is divided into blocks, and a portion thereof is additionally used as a driver electrode for a touch sensor, and the remaining portion is additionally used as a detection electrode for the touch sensor, thus mitigating an increase in thickness of the liquid crystal module.

### RELATED ART DOCUMENTS

### Patent Documents

Patent Document 1: Japanese Patent Application Laid-Open Publication, “Japanese Patent Application Laid-Open Publication No. 2010-197576 (Published on Sep. 9, 2010)”

Patent Document 2: US Patent Application Publication No. 2010/0001973 (Published on Jan. 7, 2010)

Patent Document 3: Japanese Patent Application Laid-Open Publication (Japanese Translation of PCT International Application) No. 2009-540374 (Published on Nov. 19, 2009)”

Patent Document 4: Japanese Patent Application Laid-Open Publication, “Japanese Patent Application Laid-Open Publication No. 2009-199093 (Published on Sep. 3, 2009)”

Patent Document 5: Japanese Patent Application Laid-Open Publication (Japanese Translation of PCT International Application) No. 2009-540375 (Published on Nov. 19, 2009)”

Patent Document 6: Japanese Patent Application Laid-Open Publication, “Japanese Patent Application Laid-Open Publication No. 2009-211706 (Published on Sep. 17, 2009)”

### SUMMARY OF THE INVENTION

### Problems to be Solved by the Invention

However, if the common electrode for image display is divided into a plurality of parts, at the color pixel unit, there is a difference in physical and electrical properties between pixels at a separation region, which is a gap in the common electrode, and pixels not at the separation region. As a result, the physical and electrical states become non-uniform among pixels, which causes a decrease in display quality.

The present invention was made in view of the above-mentioned problem, and an object thereof is to provide a display device with improved uniformity among pixels in terms of physical and electrical properties when a plurality of common electrodes that double as touch sensor electrodes are provided.

### Means for Solving the Problems

In order to solve the above-mentioned problem, a display device according to the present invention includes: a substrate; a plurality of pixel electrodes arranged in a matrix on a plane parallel to the substrate; a display function layer that exhibits image display functionality based on an image signal provided to the plurality of pixel electrodes; a plurality of first electrodes provided in a same layer as each other with gaps therebetween, the plurality of first electrodes generating an electric field with the pixel electrodes and thereby changing a state of the display function layer; and a plurality of second electrodes in a same layer as each other, respectively capacitively coupled with the plurality of first electrodes, wherein at least one of the plurality of first electrodes is provided with slits.

With this configuration, the display device according to the present invention includes a plurality of pixel electrodes arranged in a matrix, and a plurality of first electrodes that are respectively in the same layer. The plurality of first electrodes generate an electric field with the pixel electrodes, thus changing the state of the display function layer. Therefore, the first electrodes can function as a common electrode for realizing image display by causing the display function layer to exhibit image display functionality together with the pixel electrodes. The display device further includes a plurality of second electrodes that are in the same layer as each other, the second electrodes being capacitively coupled with the plurality of first electrodes, respectively. If a finger, a stylus, or the like approaches the second electrodes, the capacitance between the first electrodes and the second electrodes can change. Since a plurality of first electrodes and a plurality of second electrodes are respectively provided, the combination thereof allows a position to be specified where the capacitance between a first electrode and a second electrode has changed, or in other words, where a finger or a stylus has approached the device. Thus, the first electrodes and the second electrodes can also function as touch sensor electrodes.

Because the first electrodes, which can function as a common electrode, are provided with gaps therebetween, pixels with portions that do not overlap the first electrodes may exist. A degradation of display quality occurs due to changes in the electric field generated between each pixel electrode of such pixels and the first electrode even if the same image signal is sent to the respective pixel electrodes, when compared to pixels that are completely covered by the first electrodes.

However, in the display device of the present invention, slits are provided in at least one first electrode. By being provided with slits, the interior of the first electrode is provided with analogues to the gap between the first electrodes. Thus, in pixels with portions overlapping the slits, the relation between the first electrodes and the pixel electrodes of such pixels is similar to the relation between the first electrodes and the pixel electrodes of pixels having a portion that overlaps a gap between the first electrodes. As a result, it is possible to maintain uniformity between pixels that have a portion overlapping a gap between the first electrodes and pixels that do not have a portion overlapping a gap between the first electrodes, and thus, it is possible to improve display quality.

### Effects of the Invention

As stated above, in the display device of the present invention, the first electrodes that also function as image display electrodes are provided with slits. As a result, it is possible to attain uniformity between pixels that have a portion overlapping a gap between the first electrodes and pixels that do not have a portion overlapping a gap between the first electrodes.

### BRIEF DESCRIPTION OF THE DRAWINGS

FIG. 1 shows patterns of driver electrodes and slits of an embodiment of the present invention.

FIG. 2 is a cross-sectional view that shows a schematic configuration of a display device of the present embodiment.

FIG. 3 is a cross-sectional view that shows a schematic configuration of a display device of another embodiment.

FIG. 4 shows a pattern of driver electrodes and slits in the display device shown in FIG. 3.

FIG. 5 shows another example of patterns of driver electrodes and slits of the present embodiment.

FIG. 6 shows yet another example of patterns of driver electrodes and slits of the present embodiment.

FIG. 7 shows a slit pattern of the present embodiment corresponding to a pixel structure.

FIG. 8 shows a slit pattern of another embodiment corresponding to a pixel electrode.

FIG. 9 is a cross-sectional view that shows a schematic configuration of a display device of another embodiment.

FIG. 10 shows an example of patterns of driver electrodes and slits in the display device shown in FIG. 9.

FIG. 11 shows a slit pattern of another embodiment corresponding to a pixel structure.

FIG. 12 shows pixel structures of the embodiment shown in FIG. 11.

### DETAILED DESCRIPTION OF EMBODIMENTS

### Embodiment 1

### (Configuration of Display Device)

One embodiment of a display device according to the present invention will be described below.

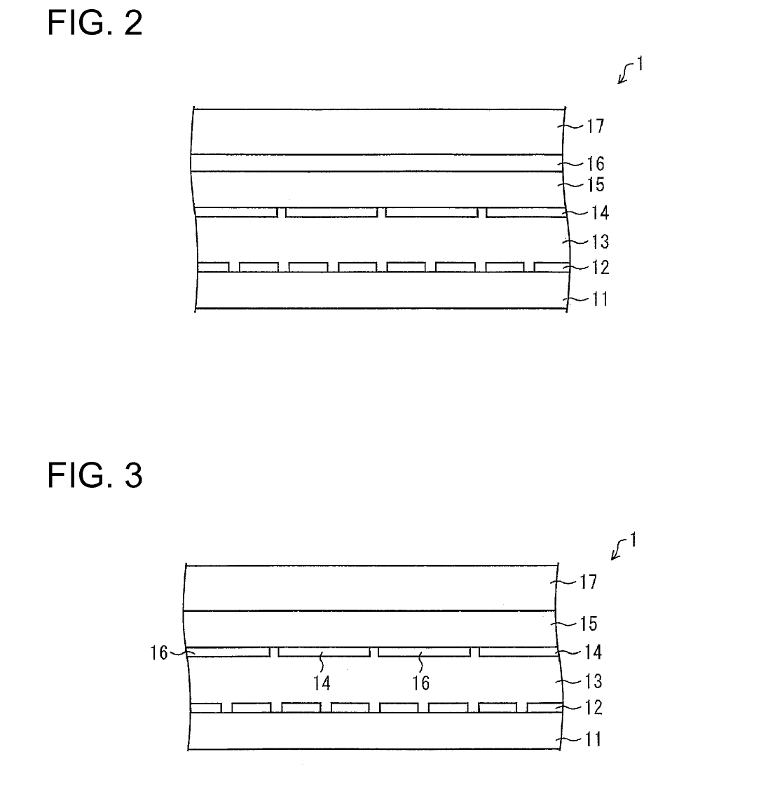

FIG. 2 is a cross-sectional view that shows a schematic configuration of a display device of the present embodiment.

A display device 1 is provided with capacitive-type touch sensors. The capacitive-type touch sensors are provided with two types of electrodes for forming capacitance in order to detect contact or an approach by a finger, a stylus, or the like. Here, the electrode that conducts scanning driving for the touch sensor is the driver electrode (first electrode), and the other electrode is the detection electrode (second electrode). In the present embodiment, in general, a display device in which the driver electrodes are provided in the display panel and the detection electrodes are provided outside of the display panel will be described. However, the present invention is not limited to this configuration, and as will be described later, both electrodes may be provided in the display panel.

As shown in FIG. 2, the display device 1 of the present embodiment includes a circuit substrate (substrate) 11, a plurality of pixel electrodes 12 arranged in a matrix on a plane parallel to the circuit substrate 11, a liquid crystal layer (display function layer) 13, driver electrodes 14 provided facing the pixel electrodes 12, an opposite substrate 15, detection electrodes 16 provided on the outer side of the opposite substrate, and a protective layer 17 for protecting these elements.

Besides thin film transistors (TFT), wiring lines, electrodes, and the like necessary for driving the liquid crystal layer 13, such as source bus lines, gate bus lines, and Cs electrodes are formed on the circuit substrate 11. In each of the matrix of regions divided by the plurality of source bus lines and the plurality of gate bus lines, a pixel electrode 12 is formed. Each of the regions corresponds to a color pixel assigned a color (here, red (R), green (G), or blue (B)).

The liquid crystal layer 13 is a layer that can realize image display by changing the orientation of liquid crystal based on an image signal supplied to the pixel electrodes 12.

The circuit substrate 11, the pixel electrodes 12, and the liquid crystal layer 13 can have conventionally known configurations of a circuit substrate, pixel electrodes, and a liquid crystal layer.

As stated above, the driver electrodes 14 are electrodes for conducting scanning driving of the touch sensors and form a capacitance with the detection electrodes 16, and the driver electrodes 14 also detect a contact position or an approach position of a finger, a stylus, or the like based on detected changes in the capacitance. Here, the driver electrodes 14 are provided facing the pixel electrodes 12, and also function as a common electrode that conducts Vcom driving for image display. The respective driver electrodes 14 are disposed at a distance from each other with gaps therebetween. FIG. 2 is simply a drawing for showing the driver electrodes 14 disposed at a distance from each other, and therefore, the separation pattern of the driver electrodes 14 in FIG. 2 does not necessarily correspond to that of the real device.

Of the plurality of driver electrodes 14, at least one driver electrode 14 has slits, and it is preferable that all driver electrodes 14 have slits. If all driver electrodes 14 have slits, it is preferable that the respective driver electrodes 14 have slits of the same form (pattern, shape, size). Details on the slits in the driver electrodes 14 will be described below.

The opposite substrate 15 is provided with color filters of R, G, or B on one side thereof in positions corresponding to the color pixels of each color.

The detection electrodes 16 are electrodes that capacitively couple respectively with the plurality of driver electrodes 14, and the respective detection electrodes 16 are formed in the same layer as each other. The number and shape of the detection electrodes 16 can be determined according to desired function and performance of the touch sensors.

### (Driver Electrodes)

The driver electrodes 14 are configured as a plurality of electrodes in the same layer as each other for detecting a position of a finger, a stylus, or the like on a touch sensor. The driver electrodes 14 are each separated from each other, and a separation region (gap) 21 is formed between each driver electrode 14. Here, the driver electrodes 14 also function as a common electrode, and thus, are provided covering substantially the entire surface of the liquid crystal layer 13. The number and shape of the driver electrodes 14 can be determined according to desired function and performance of the touch sensors.

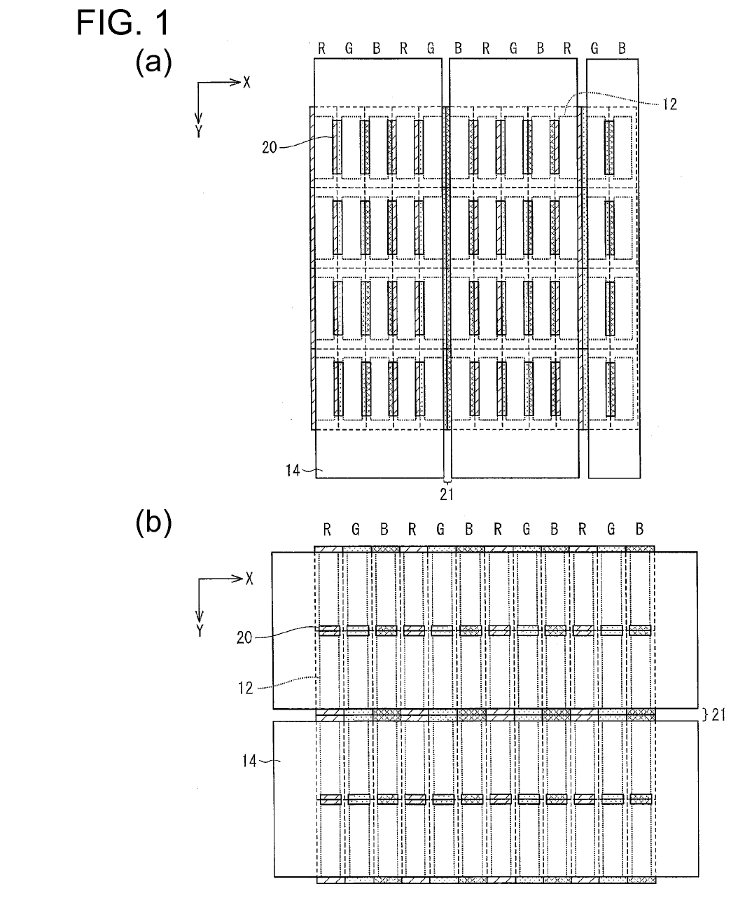

FIG. 1 shows patterns of the driver electrodes 14 and slits 20 provided in the driver electrodes 14, and, for ease of description, only shows respective color pixels (including the pixel electrodes 12) and driver electrodes 14 (including slits 20). Because the driver electrodes 14 are transparent electrodes, normally, color pixels are seen through the driver electrodes 14 even in regions where the slits 20 are not provided, in addition to portions where the slits 20 are provided, but for ease of description, in the affixed drawings, the pixels in portions overlapping the driver electrodes 14 are shown with broken lines.

As shown in FIG. 1(a), in the present embodiment, the driver electrodes 14 are belt-shaped electrodes that extend in the column direction (direction along the Y arrow in the drawing, simply referred to as the column direction below) of the matrix constituted of the color pixels. The belt-shaped plurality of driver electrodes 14 are aligned in the row direction (direction along the X arrow in the drawing, simply referred to as the row direction below) of the matrix constituted of the color pixels. The separation regions 21 in this case are formed so as to extend along the column direction. Each driver electrode 14 is formed such that the separation regions 21 overlap respective column direction sides of specific color pixels.

FIG. 1(b) shows another example of an arrangement of driver electrodes. As shown in FIG. 1(b), the driver electrodes 14 may be belt-shaped electrodes that extend in the row direction, aligned in the column direction. The separation regions 21 in this case are formed so as to extend along the row direction. Each driver electrode 14 is formed such that the separation regions 21 overlap respective row direction sides of color pixels.

Because the driver electrodes 14 also function as a common electrode, it is preferable that the driver electrodes 14 be provided over the pixel electrodes 12, facing the pixel electrodes 12, in order to prevent degradation in display quality. In other words, it is preferable that each driver electrode 14 be provided such that the separation regions 21 between the driver electrodes 14 do not overlap the pixel electrodes 12.

(Slits)

The driver electrodes 14 are provided with at least one, and preferably a plurality of slits 20 aligned along at least one of the row direction and the column direction. As shown in FIG. 1(a), in the present embodiment, the plurality of slits 20 having the same shape and extending along the column direction are aligned along the row direction and the column direction. In the case shown in FIG. 1(a), the slits 20 are provided in the driver electrodes 14 over the boundaries between all of the color pixels adjacent to each other in the row direction, in all rows of pixels. Thus, slits 20 are provided in the driver electrodes 14 over boundaries between all color pixels: between R and G; between G and B; and between B and R. However, if the boundary corresponds to the separation region 21 between the driver electrodes 14, slits 20 in the driver electrodes 14 are not present in this position, since the driver electrodes 14 are not present over this boundary.

If a plurality of belt-shaped driver electrodes are aligned to form an opposite electrode, separation regions are formed between the driver electrodes. Thus, if driver electrodes not provided with slits are used as an opposite electrode, then there is a mixture of color pixels having a side overlapping the separation region and color pixels in which all sides thereof are covered by the opposite electrode. There is a physical difference between color pixels that have a side overlapping a separation region and color pixels in which all sides thereof are covered by the opposite electrode, and thus, even if the same image signal is supplied thereto, the electrical state is not necessarily the same among the color pixels. As a result, a difference in liquid crystal orientation occurs, thus causing a degradation of display quality such as display unevenness. If, in order to mitigate this, the separation regions 21 between the driver electrodes 14 are sufficiently shielded from light, this results in a decrease in aperture ratio, causing a degradation of display quality in the liquid crystal panel.

On the other hand, in the display device 1, as stated above, slits 20 are provided in the driver electrodes 14 over boundaries between color pixels adjacent to each other in the row direction. Because there are no electrodes in the slit 20 portion, even in color pixels that would normally be in positions having all sides completely covered by an opposite electrode, the slits 20 allow such color pixels to have a similar state to color pixels with a side (side in the column direction) overlapping a separation region 21. As a result, the physical and electrical states of color pixels that do not have a side overlapping the separation region 21 are similar to the physical and electrical states of color pixels having a side overlapping the separation region 21, and thus, it is possible to attain physical and electrical uniformity among the color pixels. Therefore, as a result of the driver electrodes 14 being provided with the slits 20, it is possible to prevent the occurrence of differences in liquid crystal orientation among color pixels, thus mitigating the occurrence of display unevenness.

In the present embodiment, the slits 20 are provided in the driver electrodes 14 in positions corresponding to all of the boundaries between R and G color pixels, G and B color pixels, and B and R color pixels. As a result, this configuration is effective regardless of whether the boundary of color pixels overlapping the separation region 21 is formed by a combination of R and G, G and B, or B and R. In this case, the slits 20 are formed at the same pitch in the row direction as the pitch between the color pixels in the row direction. Also, because the slits 20 are formed similarly for all rows of pixels, the slits 20 are formed with the same pitch as the color pixels in the column direction.

As shown in FIG. 1(b), in the display device 1 having a plurality of belt-shaped driver electrodes 14 extending along the row direction and aligned along the column direction, a plurality of slits 20 with the same shape and extending along the row direction are aligned in the row direction. In the case of a configuration in which the plurality of belt-shaped driver electrodes 14 extending along the row direction are aligned in the column direction, color pixels having a side along the row direction overlapping the separation region 21 and color pixels that do not have a side overlapping the separation region 21 may be included (for example, if the length of the side of the driver electrode 14 along the column direction is three times the length of a side of a color pixel along the column direction). However, in the display device 1 shown in FIG. 1(b), slits 20 are provided in the driver electrodes 14 over boundaries of all color pixels adjacent to each other in the column direction, in all columns of pixels. However, if the separation region 21 between the driver electrodes 14 is over a boundary, slits 20 in the driver electrodes 14 are not present in this position, since the driver electrodes 14 are not present over this boundary.

Even in the configuration shown in FIG. 1(b), pixels in which all sides would be covered by an opposite electrode if slits 20 were not provided have similar physical and electrical states to pixels with a side overlapping a separation region 21, due to the presence of the slits 20. Thus, uniformity in physical and electrical properties is attained between pixels having a side overlapping a separation region 21 and pixels that do not have a side overlapping a separation region 21. Therefore, it is possible to prevent the occurrence of differences in liquid crystal orientation among pixels, thus mitigating the occurrence of display unevenness.

The patterned driver electrodes 14 and slits 20 may be formed using a known conventional patterning technique.

With a slit forming method of the present embodiment, it is possible to increase the flexibility by which patterns for separating the driver electrodes 14 are formed.

Also, in the present embodiment, the separation regions 21 are not limited to being formed between color pixels of specific colors, but when the separation regions 21 are formed between color pixels of specific colors, and if physical effects caused by the presence of the separation region 21 affect display quality, such as the viewing angle of only color pixels with a portion overlapping the separation regions 21 becoming narrow, for example, then it is preferable that the pattern of slits 20 of the present embodiment be formed.

### Embodiment 2

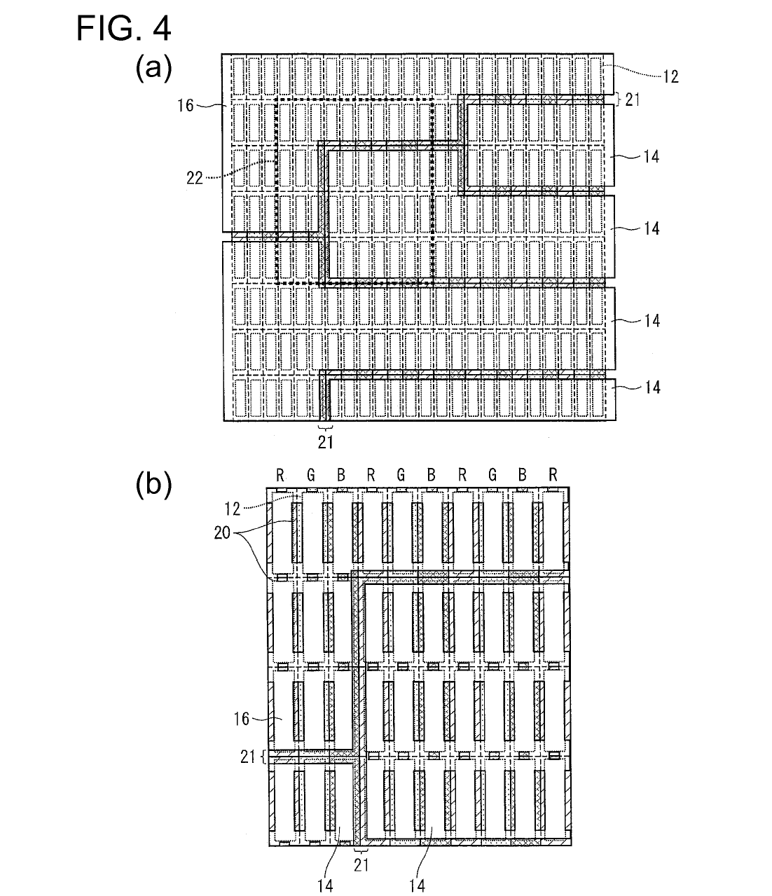

Another embodiment of a display device according to the present invention is as described below with reference to FIGS. 3 and 4. For ease of description, members having the same functions as those used in the previous embodiment are assigned the same reference characters with descriptions thereof being omitted.

FIG. 3 is a cross-sectional view that shows a schematic configuration of a display device of the present embodiment.

In the previous embodiment, the driver electrodes 14 were on the inner side of the circuit substrate 11 and the opposite substrate 15 and doubled as a common electrode for image display, and the detection electrodes 16 were formed on the outer side of the opposite substrate 15. By contrast, in a display device 1 according to the present embodiment, as shown in FIG. 3, detection electrodes 16 are on the inner side of the circuit substrate 11 and the opposite substrate 15, and are formed in the same layer as driver electrodes 14. In addition, both the driver electrodes 14 and the detection electrodes 16 double as a common electrode. Thus, slits 20 are also formed in the detection electrodes 16. As in FIG. 2, FIG. 3 is simply a drawing for showing that the driver electrodes 14 and the detection electrodes 16 are disposed at a distance from each other in the same layer, and thus, the separation pattern of the driver electrodes 14 and the detection electrodes 16 in FIG. 3 does not necessarily correspond to that of the real device.

FIG. 4 shows one example of a pattern of the driver electrodes 14, the detection electrodes 16, and the slits 20 of the present embodiment. FIG. 4(a) shows a portion of the patterned driver electrodes 14 and detection electrodes 16, and for ease of description, the slits 20 in each electrode are omitted. As shown in FIG. 4(a), the driver electrodes 14 and the detection electrodes 16 both form appropriate island shapes, and a combination thereof functions as a common electrode that covers substantially the entire surface of the liquid crystal layer 13. The display device disclosed in Patent Document 2 is known as an example of a display device having such driver electrodes and detection electrodes. Therefore, the entire description in Patent Document 2 can be incorporated by reference in the present specification.

FIG. 4(b) is a drawing that magnifies the dotted line frame 22 portion in FIG. 4(a), shown without omitting the slits 20. In the display device 1 in which the common electrode is separated into islands, separation regions 21 that are gaps between the driver electrodes 14 or between a driver electrode 14 and a detection electrode 16 can either be formed along the row direction or formed along the column direction.

In the display device 1 according to the present embodiment, slits 20 having the shape and pattern shown in FIG. 1(a) of Embodiment 1 (slits extending along the column direction of the pixels), and slits 20 having the pattern and shape shown in FIG. 1(b) (slits extending along the row direction of the pixels) are both formed in each driver electrode 14 and each detection electrode 16.

In the case of island-shaped electrodes, there may be not only color pixels that have one side overlapping a separation region 21, but also color pixels that have two perpendicular sides overlapping a separation region 21. In the display device 1 of the present embodiment, slits 20 are provided in the driver electrodes 14 or the detection electrodes 16 in positions corresponding to the boundaries between adjacent color pixels in the row direction and the column direction. Thus, even in the case of a display device in which a plurality of island-shaped driver electrodes 14 and detection electrodes 16 are in the same layer and function as a common electrode, it is possible to attain uniform physical and electrical states among pixels having a side overlapping the separation region 21 and pixels that do not have a side overlapping the separation region 21.

### Embodiment 3

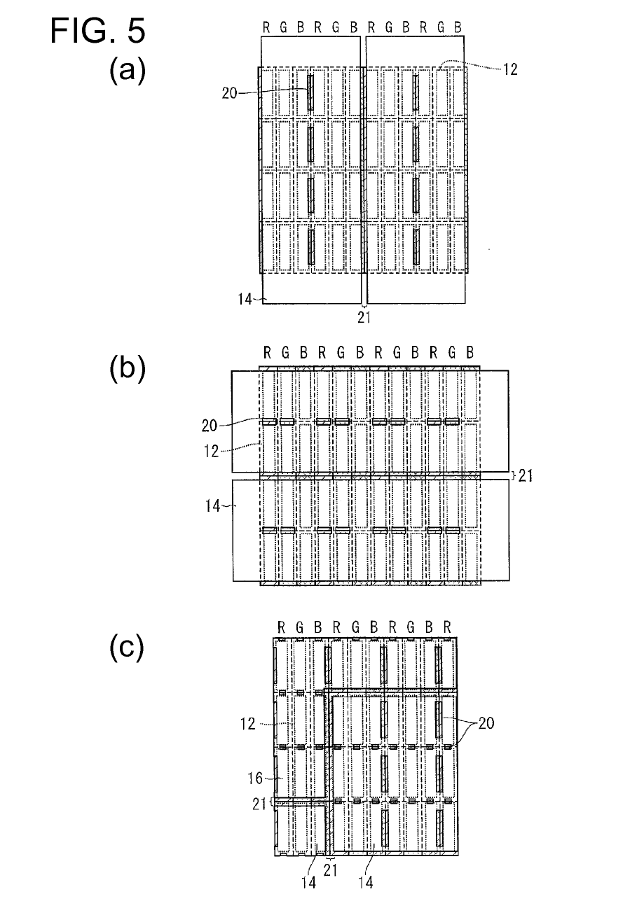

Another embodiment of a display device according to the present invention is as described below with reference to FIG. 5. For ease of description, members having the same functions as those used in the previous embodiments are assigned the same reference characters with descriptions thereof being omitted.

In Embodiment 1 described above, the slits 20 were provided in positions in the driver electrodes 14 corresponding to all boundaries between adjacent color pixels, in at least one of the row direction and the column direction. In other words, the slits 20 were provided with the same pitch as the pitch between the color pixels in that direction.

By contrast, in a display device 1 of the present embodiment, slits 20 are formed only between color pixels of specific colors.

FIGS. 5(a) to 5(c) show examples of patterns of the driver electrodes 14 or the detection electrodes 16, and the slits 20 in the present embodiment. For ease of description, only the color pixels (including the pixel electrodes 12) and the driver electrodes 14 (driver electrodes 14 and detection electrodes 16 in FIG. 5(c)) (including slits 20) are shown. As shown in FIG. 5(a), in the present embodiment, each driver electrode 14 is a belt-shaped electrode that extends along the column direction, and by aligning these driver electrodes 14 in the row direction, the driver electrodes 14 function as a common electrode that covers substantially the entire liquid crystal layer 13. In this case, the separation regions 21 extend along the column direction. Each driver electrode 14 is provided such that the separation regions 21 are formed over boundaries between blue pixels (B) (first color pixels) and red pixels (R) (second color pixels) adjacent to each other in the row direction.

The slits 20 in the driver electrodes 14 are formed in the portion of the driver electrodes 14 overlapping the boundaries between the blue pixels (B) and the red pixels (R) that are adjacent to each other in the row direction. In other words, when the separation regions 21 between the driver electrodes 14 are formed over the boundaries of color pixels of specific colors, slits 20 are formed in positions of the driver electrodes 14 corresponding to boundaries between color pixels with the same combination of specific colors for pixels that do not overlap a separation region 21. Here, the color pixels of specific colors are the blue pixel (B) and the red pixel (R), but the color combination is not limited thereto.

If slits 20 are not formed in the driver electrodes 14, sets of blue pixels and red pixels that have a side not covered by a driver electrode 14 due to overlapping a separation region 21, and sets of blue pixels and red pixels in which all sides thereof are covered by the driver electrodes 14 due to not overlapping the separation region 21 can both exist. In this case, it is possible for non-uniformity in physical and electrical states to occur among blue pixels and among red pixels, thus resulting in a degradation of display quality.

As a countermeasure, in the display device 1, for all blue pixels and red pixels, a side of a blue pixel (side adjacent to a red pixel) and a side of a red pixel (side adjacent to a blue pixel) either overlap a separation region 21 or have a slit 20 formed thereabove. As a result, uniformity in the physical and electrical states among blue pixels and among red pixels is attained, thus preventing a degradation of display quality.

Also, unlike the display device 1 of the embodiments described above in which slits 20 are generally formed over all color pixels, the display device 1 of the present embodiment has slits 20 provided in the driver electrodes 14 in positions corresponding only to color pixels of specific colors. Thus, it is possible to keep the number of slits 20 formed in the driver electrodes 14 small, thus mitigating an increase in impedance in the electrodes.

FIG. 5(b) shows another example of the present embodiment. The driver electrodes 14 shown in FIG. 5(b) are belt-shaped electrodes that extend along the row direction, and are aligned along the column direction. The separation regions 21 in this case are formed so as to extend along the row direction. Also, each of the driver electrodes 14 is formed such that the separation regions 21 therebetween overlap a side of the color pixels in the row direction.

In Embodiment 1 described above, slits 20 were formed over boundaries between color pixels of the respective same colors adjacent to each other in the column direction, for color pixels of all colors. By contrast, in the display device 1 shown in FIG. 5(b), slits 20 are formed over boundaries between color pixels adjacent to each other in the column direction only for red pixels (R) and green pixels (G), and slits 20 are not formed over boundaries between blue pixels (B) adjacent to each other in the column direction. In general, it is known that blue pixels have a low visibility. Thus, the effect on display quality from a presence or lack of a slit 20 is less for the vicinity of blue pixels compared to other color pixels. Thus, if the number of slits 20 formed in the driver electrodes 14 is to be reduced in order to mitigate an increase in impedance in the electrodes, it is possible to mitigate a worsening of visibility while mitigating an increase in impedance by not forming slits 20 in the vicinity of the blue pixels, which have a low visibility.

FIG. 5(c) shows yet another example of the present embodiment. The display device 1 of FIG. 5(c) has the same configuration as the display device 1 of Embodiment 2 with the exception of the configuration of the slits 20.

In the display device 1 of FIG. 5(c), driver electrodes 14 and detection electrodes 16 are formed in island shapes in the same layer, and both have two types of slits 20 formed therein. One type of slit 20 is similar to that of the display device 1 shown in FIG. 5(a) in being formed only over the boundaries of color pixels of specific colors (between blue pixels (B) and red pixels (R) in this case), and extending along the column direction. There are separation regions 21 that extend in the row direction and separation regions 21 that extend in the column direction, but the separation regions 21 that extend in the column direction are positioned over the boundaries between color pixels of specific colors (between the blue pixel (B) and the red pixel (R)). The other type of slits 20 are similar to that of the display device 1 of FIG. 1(b) in being formed over the boundaries between all pixels adjacent to each other in the column direction, and extending along the row direction.

In the configuration shown in FIG. 5(c), for all blue pixels and red pixels, a separation region 21 or a slit 20 is formed over a side of the blue pixel (side adjacent to the red pixel) and a side of the red pixel (side adjacent to the blue pixel). As a result, uniformity in the physical and electrical states among blue pixels and among red pixels is attained, thus preventing a degradation of display quality. Also, it is possible to keep the number of slits 20 formed in the driver electrodes 14 and detection electrodes 16 small, thus mitigating an increase in impedance in the electrodes.

### Embodiment 4

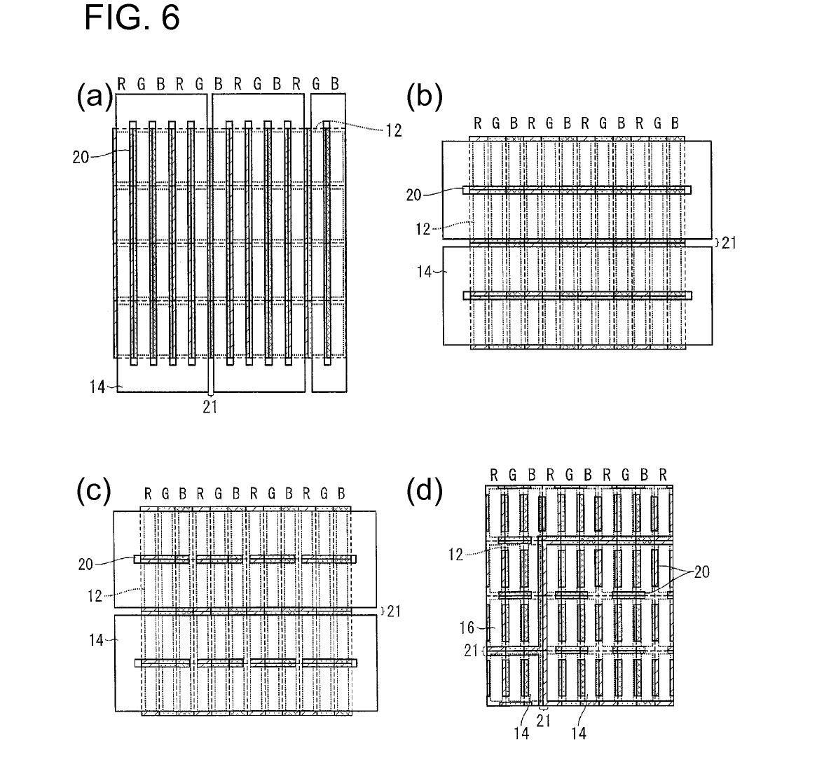

Another embodiment of a display device according to the present invention is as described below with reference to FIG. 6. For ease of description, members having the same functions as those used in the previous embodiments are assigned the same reference characters with descriptions thereof being omitted.

In Embodiments 1 to 3 described above, the length of the slits 20 extending in the column direction was shorter than the side of the region constituting the color pixel (pixel area) parallel to the column direction. Similarly, the length of the slits 20 extending in the row direction was shorter than the side of the region constituting the color pixel parallel to the row direction.

By contrast, in a display device 1 of the present embodiment, the length of the slits 20 extending in the column direction is longer than the side parallel to the column direction of the region constituting the color pixel, and the length of the slits 20 extending in the row direction is longer than the side parallel to the row direction of the region constituting the color pixel.

FIGS. 6(a) to 6(d) show examples of patterns of the driver electrodes 14 or the detection electrodes 16, and the slits 20 in the present embodiment. For ease of description, only the color pixels (including the pixel electrodes 12) and the driver electrodes 14 (driver electrodes 14 and detection electrodes 16 in FIG. 6(d)) (including slits 20) are shown.

In the display device 1 shown in FIG. 6(a), belt-shaped driver electrodes 14 extending in the column direction are aligned in the row direction, thus functioning as a common electrode that covers substantially the entire liquid crystal layer 13. In this case, the slits 20 extend in the column direction, and the length thereof spans over a plurality of color pixels in the column direction. As in Embodiment 1, the slits 20 are formed at all boundaries between color pixels adjacent to each other in the row direction. However, the position of the slits 20 is not limited thereto, and may alternatively be formed only between color pixels of specific colors as shown in FIG. 5(a).

As shown in FIG. 6(a), if one slit 20 is formed spanning over a plurality of color pixels, it is possible to have the physical and electrical states in the vicinity of the slits 20 to be closer to the states in the vicinity of the separation regions 21, compared to a case in which slits 20 are formed for each color pixel as in the embodiments described above. Thus, it is possible to more reliably maintain uniform physical and electrical states between color pixels having a portion overlapping a separation region 21 and color pixels that do not have a portion overlapping a separation region 21, thus further improving display quality.

In the display device 1 shown in FIGS. 6(b) and 6(c), belt-shaped driver electrodes 14 extending in the row direction are aligned in the column direction, thus functioning as a common electrode that covers substantially the entire liquid crystal layer 13. In this case, the slits 20 extend in the row direction, and the length thereof spans over a plurality of color pixels in the row direction. The slits 20 need only to span over a plurality of pixels, and the length thereof is not limited to spanning over all pixels in the row direction as shown in FIG. 6(b), and as shown in FIG. 6(c), the slits 20 may be separated between color pixels of specific colors (in this case, between blue pixels (B) and red pixels (R)).

As in the case shown in FIG. 6(b), if the slits 20 span over all pixels in the row direction, then as in the case shown in FIG. 6(a), it is possible to have the physical and electrical states in the vicinity of the slits 20 closer to the states in the vicinity of the separation regions 21. Thus, it is possible to more reliably maintain uniform physical and electrical states between color pixels having a portion overlapping a separation region 21 and color pixels that do not have a portion overlapping a separation region 21, thus further improving display quality.

In the vicinity of color pixels with high visibility colors, the effect of the presence or lack of the slits 20 on display quality is relatively high compared to color pixels of colors that do not have high visibility. It is generally known that green pixels (G) have a high visibility. Thus, it is preferable that slits 20 be provided in regions of the driver electrode 14 corresponding to the green pixels (G). As in the case shown in FIG. 6(c), although the slits 20 span over a plurality of pixels, if the slits 20 are separated between color pixels of specific colors, it is preferable that separations of the slits 20 not be provided at the green pixels (G), which have a high visibility, and that separations of the slits 20 be provided at other color pixels (R and B).

FIG. 6(d) shows yet another example of the present embodiment. The display device 1 of FIG. 6(d) has the same configuration as the display device 1 of Embodiment 2 with the exception of the configuration of the slits 20. In the display device 1 of FIG. 6(d), driver electrodes 14 and detection electrodes 16 are formed in island shapes in the same layer, and both have two types of slits 20 formed therein. One type of slits 20 extending in the column direction have the same pattern and form as the slits 20 extending in the column direction in the driver electrodes 14 and the detection electrodes 16 in the display device 1 of Embodiment 2. On the other hand, as in the case shown in FIG. 6(c), the other type of slits 20 extending in the row direction span over the red pixel (R), the green pixel (G), and the blue pixel (B), and are separated between R and B. Therefore, the present embodiment can be suitably applied even to a display device in which the driver electrodes 14 and the detection electrodes 16 are in the same layer and respectively function as a common electrode.

### Embodiment 5

In Embodiments 1 to 4 described above, the form of the slits was described from a wide perspective such as a display region. Below, the form of the slits will be described from a narrow perspective such as a pixel unit.

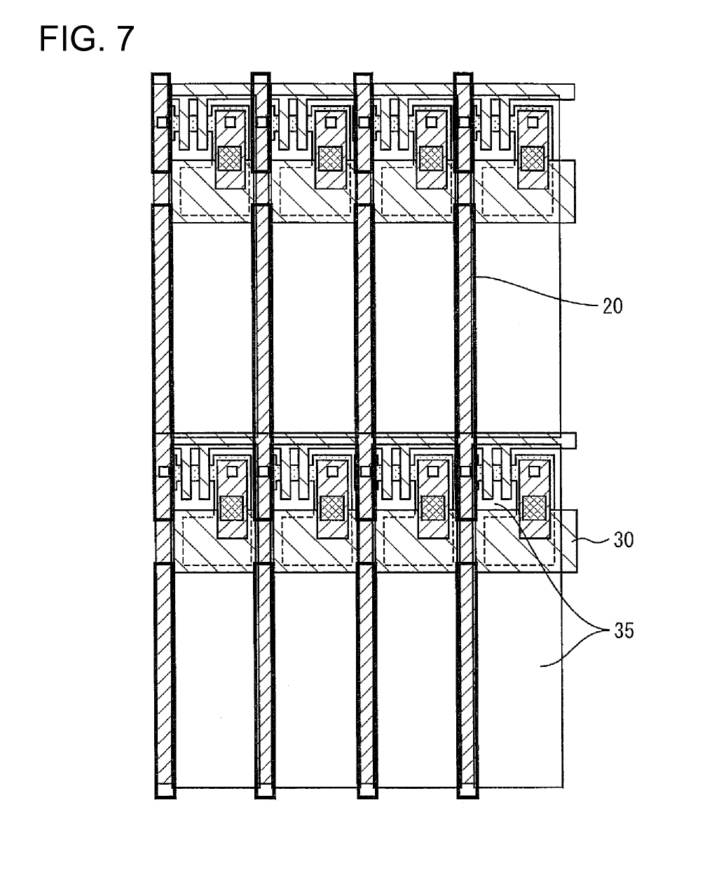

FIG. 7 shows a pixel structure from above. For ease of description, only the slits 20 are shown of the driver electrodes 14, and the driver electrodes 14 themselves are omitted.

As stated above, in a display device 1 in which a common electrode is constituted of a plurality of driver electrodes 14, there are separation regions 21 between the driver electrodes 14. There are no electrodes in the separation region 21, and thus, color pixels having a portion that overlaps a separation region 21 may have a different electric field state compared to color pixels that do not have a portion overlapping a separation region 21. Therefore, when forming the slits 20, it is preferable that slits 20 be formed in portions of the color pixels where the electric field state would change as a result of forming the slits 20, having an effect on display.

As shown in FIG. 7, each color pixel has a display contributing part 35 that directly contributes to display. Specifically, the display contributing part 35 is an opening located in a region where the pixel electrode 12 is formed. A Cs electrode 30 does not transmit light, and is therefore not included in the display contributing part 35, for example.

The slits 20 are formed in a position of such a display contributing part 35 that has an effect on the electric field. In FIG. 7, the slits 20 extend in the column direction along the display contributing parts 35. On the other hand, the Cs electrodes 30 are not parts that directly contribute to display, and thus, the slits 20 are separated thereat. By forming slits 20 in positions that have an effect on the display contributing parts 35 while not providing slits 20 in positions that do not have a direct effect on display, it is possible to maintain display quality with a uniform electric field state among the color pixels while mitigating an increase in impedance. Besides the Cs electrodes 30, the gate bus lines are also not part of the display contributing parts 35, and thus, the slits 20 may be separated over the gate bus lines.

### Embodiment 6

Another embodiment of a display device according to the present invention is as described below with reference to FIGS. 8 to 10. For ease of description, members having the same functions as those used in the previous embodiments are assigned the same reference characters with descriptions thereof being omitted.

In Embodiments 1 to 5 described above, the pixel electrodes 12 are rectangular, and the slits 20 have a rectangular shape with a side parallel to one side of the rectangular pixel electrode 12.

By contrast, in the display device 1 of the present embodiment, pixel electrodes 12 are comb-shaped electrodes with a zigzag shape, and a portion of each slit 20 has a shape following the zigzag portion of the pixel electrodes 12.

FIG. 8 shows an example of patterns of the pixel electrodes 12 and driver electrodes 14 of the present embodiment. In FIG. 8, for ease of description, only the pixel electrodes 12 and the slits 20 in the driver electrodes 14 are shown.

The display device 1 of the present embodiment is an IPS (in-plane switching) mode (or AFFS (advanced fringe field switching) mode) liquid crystal display device. Thus, unlike the display device 1 of the embodiments described above, as shown in FIG. 8, the pixel electrodes 12 are comb-shaped electrodes.

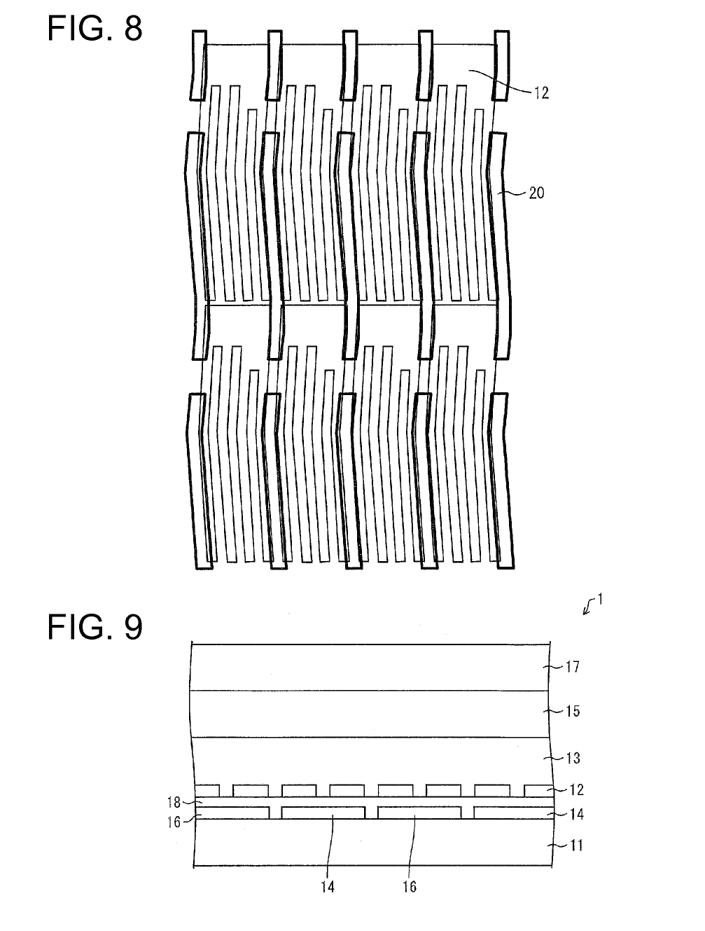

FIG. 9 is a cross-sectional view that shows a schematic configuration of the display device 1 of the present embodiment. In the display device 1 of the present embodiment, the driver electrodes 14 and the detection electrodes 16 function as a common electrode. As shown in FIG. 9, the driver electrodes 14 and the detection electrodes 16 that function as a common electrode are formed between the pixel electrodes 12 and the circuit substrate 11, the driver electrodes 14 and the detection electrodes 16 being separated from the pixel electrodes 12 by an insulating film 18. By generating a transverse electric field between the comb-shaped pixel electrodes 12, and the driver electrodes 14 or the detection electrodes 16 located in a layer below each comb shape, the orientation of liquid crystal in the liquid crystal layer 13 is changed.

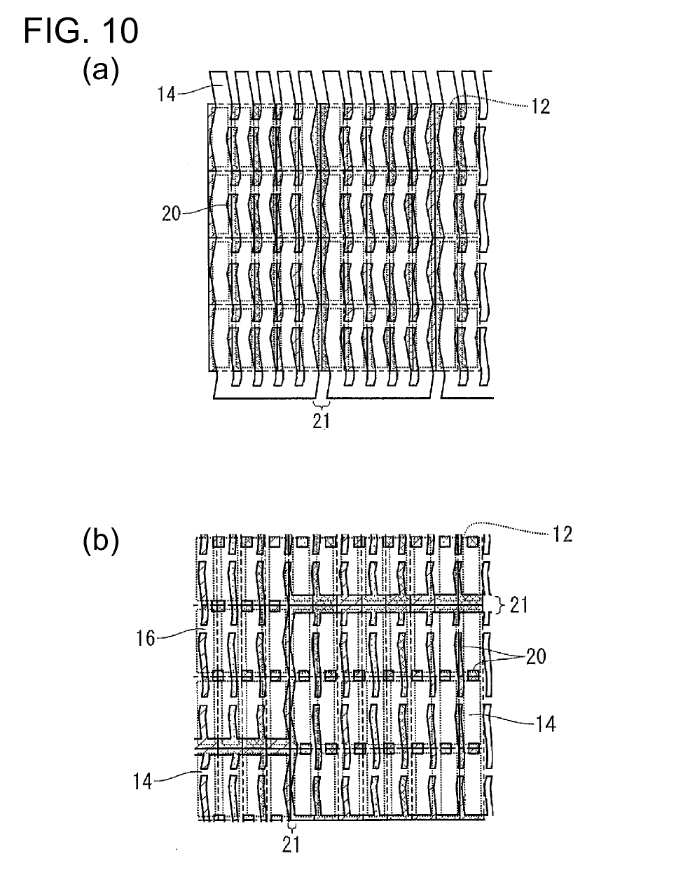

FIG. 10(a) shows an example of a pattern of the pixel electrodes 12, the driver electrodes 14, and the slits 20 of the present embodiment, and FIG. 10(b) shows an example of a pattern of the pixel electrodes 12, the driver electrodes 14, the detection electrodes 16, and the slits 20 of a different example of the present embodiment. The comb-shaped pixel electrode 12 provided for each color pixel in the present embodiment has a structure in which the entirety thereof has a bent shape in a zigzag form. Separation regions 21 between the driver electrodes 14 or between a driver electrode 14 and a detection electrode 16 are formed along the pixel electrode 12, and portions of the sides of the driver electrode 14 and the detection electrode 16 follow the bent shape of the pixel electrodes 12. In other words, the shape is follows the shape of the side of the pixel electrode 12. In this case, the separation region 21 between the driver electrodes 14 or between a driver electrode 14 and a detection electrode 16 has a shape that follows the pixel electrode 12, and thus, it is possible to keep the effect of the separation regions 21 on the sides of the pixel electrodes 12 uniform and minimal for each color pixel.

Similarly, the slits 20 are also provided following the pixel electrodes 12, and the portion of the side has a shape that follows the bend in the pixel electrode 12. In other words, the shape follows the shape of the side of the pixel electrode 12.

As stated above, the slits 20 have a shape that follows the pixel electrodes 12 and that also corresponds to the separation regions 21, and the effect of slits 20 in the side of the pixel electrodes 12 on image display is almost the same as the effect of the separation regions 21 on image display, and as a result, it is possible to maintain uniform display quality over substantially the entire surface. In the present embodiment, an example of zigzag comb-shaped electrodes and slits with a shape that corresponds thereto was described, but as long as the slits have a shape that follows the side of the pixel electrodes, any shape can be used.

### Embodiment 7

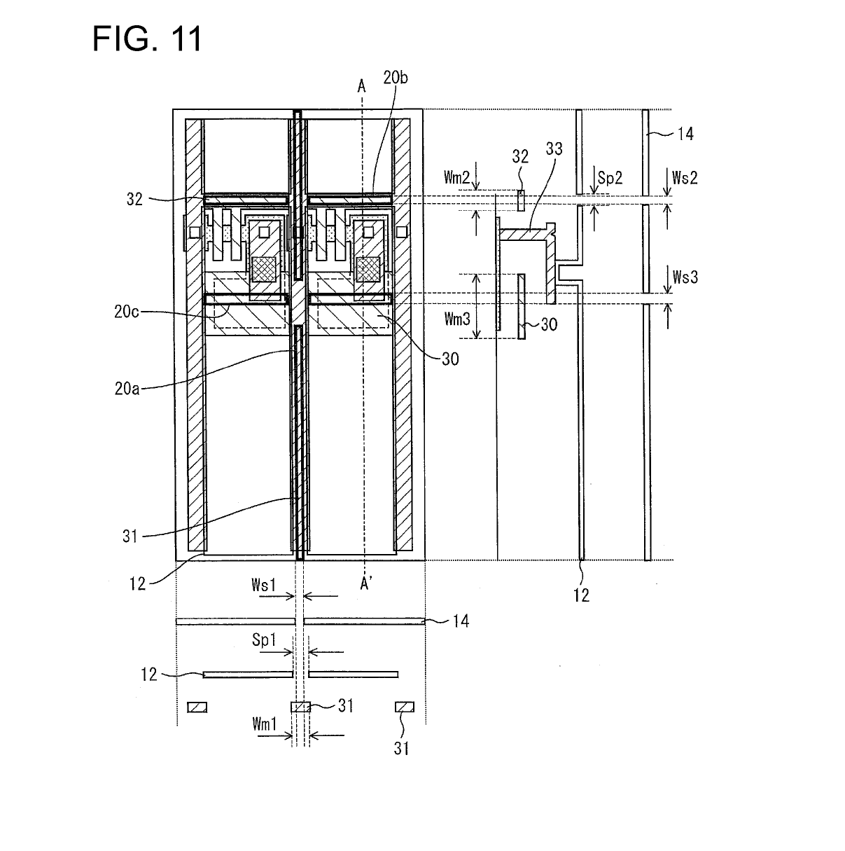

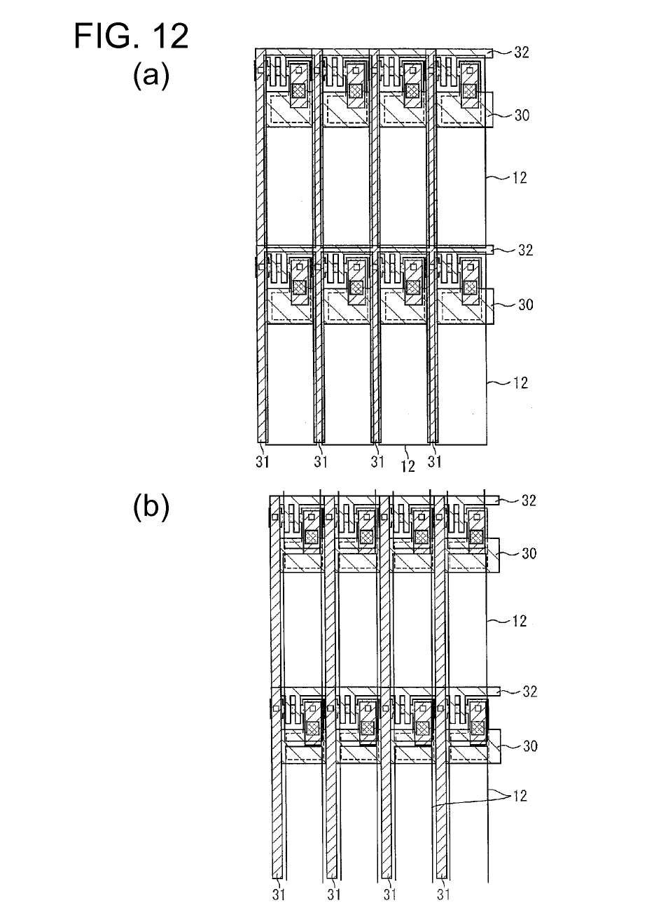

Another embodiment of a display device according to the present invention is as described below with reference to FIGS. 11 and 12. For ease of description, members having the same functions as those used in the previous embodiments are assigned the same reference characters with descriptions thereof being omitted.

In a conventional pixel structure, regions that do not transmit light due to being provided with wiring lines such as gate bus lines and source bus lines or Cs electrodes and the like, and regions that do not have a pixel electrode do not directly contribute to image display. In a display device of the present embodiment, by providing slits in such regions that do not directly contribute to image display, it is possible to minimize degradation of display quality.

FIG. 11 shows a pattern of slits 20 of the driver electrode 14 in each pixel in a display device of the present embodiment. The lower part of the drawing is a cross-section along the row direction of the configuration in the upper left portion of the drawing, and the right side of the drawing shows a cross-section along the dashed line A-A′ in the configuration shown in the upper left portion of the drawing. As shown in FIG. 11, in a display device 1 of the present embodiment, the slits 20 are provided in a plurality of locations. A first slit 20a is formed in a position that overlaps a source bus line 31 that extends along the column direction. A second slit 20b is formed in a position that overlaps a gate bus line 32 that extends along the row direction. A third slit 20c is formed extending along the row direction in a region that overlaps a Cs electrode 30. The source bus line 31 and the gate bus line 32 are provided in positions that overlap the areas between adjacent pixel electrodes 12. Thus, regions that do not have a pixel electrode 12 are regions on either the source bus line 31 or the gate bus line 32.

A width Ws1 of the slit 20a (length along the row direction) and a width Wm1 of the source bus line 31 satisfy Ws1≦Wm1. Similarly, the width Ws1 of the slit 20a and a width Sp1 of a gap extending in the column direction between the pixel electrodes 12 satisfy Ws1≦Sp1.

Similarly, a width Ws2 of the slit 20b (length along the column direction) and a width Wm2 of the gate bus line 32 satisfy Ws2≦Wm2. Similarly, the width Ws2 of the slit 20b and a width Sp2 of a gap extending in the row direction between the pixel electrodes 12 satisfy Ws2≦Sp2.

The slit 20a and the slit 20b are over the source bus line 31 and the gate bus line 32, which respectively do not directly contribute to display, and both have a width less than or equal to the respective wiring lines. Also, both the slit 20a and the slit 20b are in regions that do not have a pixel electrode 12 and do not directly contribute to display (above the gaps between the pixel electrodes 12), and both have a width less than or equal to each gap. Therefore, both the slit 20a and the slit 20b are not in regions that directly contribute to display, and as a result, it is possible to minimize degradation of display quality due to the slits.

A width Ws3 of the slit 20c (length along the column direction) and a width Wm3 of the Cs electrode 30 (length along the column direction) satisfy Ws3≦Wm3. In other words, the slit 20c is over the Cs electrode 30, which does not directly contribute to display, and the width of the slit is less than or equal to the width of the Cs electrode 30. Thus, the slits 20c are not in regions that directly contribute to display, and as a result, it is possible to minimize degradation of display quality due to the slits.

The slit 20a and the slit 20b in the present embodiment both fulfill two conditions on the width (Ws≦Sp, Ws≦Wm), but if at least one of the width Wm of the wiring lines and the width Sp between the pixel electrodes is sufficiently larger than the other, then there may be cases in which only one of the two conditions needs to be fulfilled.

FIG. 12 omits the driver electrodes 14 and the slits 20 and shows only configurations of each color pixel. FIG. 12(a) corresponds to the configuration shown in FIG. 11, and each pixel electrode 12 is formed such that pixel electrodes 12 adjacent to each other in the column direction have a gap over the gate bus line 32. However, the position of the pixel electrodes 12 is not limited thereto. For example, as shown in FIG. 12(b), each pixel electrode 12 may be formed such that the gap between pixel electrodes 12 adjacent to each other in the column direction is over the Cs electrode 30.

As shown in FIG. 12(b), if the gap between the pixel electrodes 12 in the column direction is positioned above the Cs electrode 30, then generally, the Cs electrode 30 is sufficiently wide with respect to the gap between the pixel electrodes 12. Thus, when providing a slit 20 over the Cs electrode 30, it is possible to have a configuration in which the gap between the pixel electrodes 12 in the column direction (Sp2 in FIG. 11) is less than or equal to the width of the slit 20 (Ws2 in FIG. 11), which is less than or equal to the width of the Cs electrode 30 (Wm3 in FIG. 11).

In the configuration shown in FIG. 12(b), minimization of the load on the source bus line 31 is prioritized, and (the width of the source bus line (Wm1 in FIG. 11))≦(the gap between the pixel electrodes 12 in the row direction (Sp1 in FIG. 11)) is satisfied. In such a case, (the width of the source bus line (Wm1 in FIG. 11))≦(the width of the slit 20 (Ws1 in FIG. 11))≦(the gap between the pixel electrodes 12 in the row direction (Sp1 in FIG. 11)) is satisfied. Such a configuration is also included in the scope of the present invention.

In addition to the present embodiment, if slits 20 extending in the column direction and slits 20 extending in the row direction are both formed, the width of the slits 20 extending in the column direction does not need to be the same as the width of the slits 20 extending in the row direction.

The present invention is not limited to the above-mentioned embodiments, and various modifications can be made without departing from the scope of the claims. That is, embodiments obtained by combining techniques modified without departing from the scope of the claims are also included in the technical scope of the present invention.

In the display device according to the present invention, it is preferable that each of the slits be provided over a boundary between pixel areas that are adjacent to each other in a row direction or a column direction.

If a common electrode is separated into a plurality of parts, then the common electrode is formed such that separation regions, which are gaps between the parts of the common electrode, are positioned over boundaries of adjacent pixels, in order to maintain display quality. Therefore, by providing the slits over the boundary between pixel areas adjacent to each other in the row direction or the column direction, it is possible to have a state similar to pixels having an overlapping portion with a separation region. As a result, it is possible to improve uniformity among pixels that have an overlapping portion with the separation region and pixels that do not have an overlapping portion with a separation region.

Also, in the display device according to the present invention, it is preferable that the slits be provided with a same pitch as a pitch between the pixel areas adjacent to each other in the row direction or the column direction.

With this configuration, a slit is formed over each pixel in a group of pixels in a row or a group of pixels in a column, and the position of the slits correspond to the same parts of the respective pixels. As a result, it is possible to further improve the uniformity among pixels.

Also, in the display device according to the present invention, it is preferable that a gap between adjacent first electrodes be positioned over a boundary between a pixel area corresponding to a first color pixel, and a pixel area adjacent to the aforementioned pixel area and corresponding to a second color pixel that differs from the first color pixel, and that each of the above-mentioned slits be provided over a boundary between the pixel area corresponding to the first color pixel, and the pixel area adjacent to the aforementioned pixel area and corresponding to the second color pixel, in a region covered by one of the first electrodes.

With this configuration, a slit is provided corresponding to color pixels of the same colors as the color pixels where a gap between the first electrodes is located. As a result, it is possible to mitigate the occurrence of non-uniformity in physical and electrical states among same color pixels. Also, slits only need to be provided between specific color pixels, and it is not necessary to provide slits for color pixels of the same color as color pixels where a gap is not provided, and therefore, it is possible to minimize the number of slits while mitigating an increase in impedance in the electrodes.

Also, in the display device according to the present invention, it is preferable that a length of each of the slits be shorter than a length of one side of each of the pixel areas where the boundary is formed.

With this configuration, it is possible to provide a slit for each pixel, thus increasing the flexibility of patterning while decreasing the total area of the slits, which mitigates an increase in impedance in the electrodes.

Also, in the display device according to the present invention, it is preferable that a length of each of the slits be longer than a length of one side of each of the pixel areas where the boundary is formed.

With this configuration, slits are made more analogous to the gap between the first electrodes, thus improving the uniformity among the color pixels.

Also, in the display device according to the present invention, it is preferable that the plurality of second electrodes be formed in a same layer as the plurality of first electrodes, that the second electrodes double as an electrode that generates an electric field with the pixel electrodes, thus changing a state of the display function layer, and that at least one of the plurality of second electrodes have slits provided with a same shape as the slits provided in each of the first electrodes.

With this configuration, the plurality of second electrodes are in the layer where the plurality of first electrodes are formed, and the second electrodes and the first electrodes can function as a common electrode for image display. Similarly, slits for mitigating the non-uniformity among color pixels are provided in the second electrodes. With this configuration, uniformity can be attained and the display quality can be maintained.

Also, in the display device according to the present invention, it is preferable that each of the slits be adjacent to a display contributing part of a pixel area that directly contributes to display.

An area that directly contributes to display is where a pixel electrode is formed, and contributes to the display of images by transmitting light. With this configuration, slits are adjacent to the display contributing part, which allows the provision of the slits to affect the display contributing part. Thus, it is possible to have an analogous effect to that of the gap between the first electrodes, thus more effectively eliminating non-uniformity among color pixels.

Also, in the display device according to the present invention, it is preferable that a shape of a side of each of the slits follow a portion of a shape of a side of each of the pixel electrodes.

With this configuration, slits are formed along the side of the pixel electrodes, and thus, it is possible to improve the uniformity among color pixels without affecting display quality at the pixel level.

Also, in the display device according to the present invention, it is preferable that the substrate include a wiring line that extends along a row direction or a column direction of the matrix, that each of the slits be provided overlapping the wiring line, and that a width of each of the slits be less than or equal to a width of the wiring line.

In general, regions with wiring lines do not transmit light, thus not directly contributing to display. Thus, with this configuration, slits are provided in regions not directly contributing to display, and thus, it is possible to further improve the uniformity among color pixels without affecting the display quality at the pixel level.

Also, in the display device according to the present invention, it is preferable that a width of each of the slits be less than or equal to a width of a gap between the pixel electrodes respectively in the adjacent pixel areas.

In regions that do not have pixel electrodes, it is not possible to have the display function layer exhibit image display functionality. Therefore, regions that do not have pixel electrodes do not directly contribute to display. Thus, with this configuration, slits are provided in regions not directly contributing to display, and thus, it is possible to further improve the uniformity among color pixels without affecting the display quality at the pixel level.

Also, in the display device according to the present invention, it is preferable that the plurality of first electrodes be provided opposite to the plurality of pixel electrodes, and that the display function layer be provided between a layer with the plurality of pixel electrodes and a layer with the plurality of first electrodes.

### INDUSTRIAL APPLICABILITY

The present invention can be used in a display device that has a display panel with a touch panel.

### DESCRIPTION OF REFERENCE CHARACTERS

1 display device
11 circuit substrate (substrate)
12 pixel electrode
13 liquid crystal layer (display function layer)
14 driver electrode (first electrode)
15 opposite substrate
16 detection electrode (second electrode)
17 protective layer
18 insulating film
20 slit
21 separation region
30 Cs electrode (wiring line)
31 source bus line (wiring line)
32 gate bus line (wiring line)

1. A display device, comprising:
a substrate;
a plurality of pixel electrodes arranged in a matrix on a plane parallel to the substrate;
a display function layer that exhibits image display functionality based on an image signal provided to the plurality of pixel electrodes;
a plurality of first electrodes provided in a same layer as each other with gaps therebetween, the plurality of first electrodes generating an electric field with the pixel electrodes and thereby changing a state of the display function layer; and
a plurality of second electrodes in a same layer as each other, respectively capacitively coupled with the plurality of first electrodes,
wherein at least one of the plurality of first electrodes is provided with slits.

2. The display device according to claim 1, wherein each of the slits is provided over a boundary between pixel areas that are adjacent to each other in a row direction or a column direction.

3. The display device according to claim 2, wherein the slits are provided with a same pitch as a pitch between the pixel areas adjacent to each other in the row direction or the column direction.

4. The display device according to claim 2,
wherein a gap between adjacent first electrodes is positioned over a boundary between a pixel area corresponding to a first color pixel, and a pixel area adjacent to said pixel area and corresponding to a second color pixel that differs from the first color pixel, and
wherein each of the slits is provided over a boundary between the pixel area corresponding to the first color pixel, and the pixel area adjacent to said pixel area and corresponding to the second color pixel, in a region covered by one of the first electrodes.

5. The display device according to claim 2, wherein a length of each of the slits is shorter than a length of one side of each of the pixel areas where the boundary is formed.

6. The display device according to claim 2, wherein a length of each of the slits is longer than a length of one side of each of the pixel areas where the boundary is formed.

7. The display device according to claim 1, wherein the plurality of second electrodes are formed in a same layer as the plurality of first electrodes, the second electrodes double as an electrode that generates an electric field with the pixel electrodes, thus changing a state of the display function layer, and at least one of the plurality of second electrodes has slits provided with a same shape as the slits provided in each of the first electrodes.

8. The display device according to claim 1, wherein each of the slits is adjacent to a display contributing part of a pixel area that directly contributes to display.

9. The display device according to claim 1, wherein a shape of a side of each of the slits follows a portion of a shape of a side of each of the pixel electrodes.

10. The display device according to claim 1,
wherein the substrate includes a wiring line that extends along a row direction or a column direction of the matrix,
wherein each of the slits is provided overlapping the wiring line, and
wherein a width of each of the slits is less than or equal to a width of the wiring line.

11. The display device according to claim 2, wherein a width of each of the slits is less than or equal to a width of a gap between the pixel electrodes respectively in the adjacent pixel areas.

12. The display device according to claim 1,
wherein the plurality of first electrodes are provided opposite to the plurality of pixel electrodes, and
wherein the display function layer is provided between a layer with the plurality of pixel electrodes and a layer with the plurality of first electrodes.
